(19) United States
(12) Patent Application Publication
(10) Pub. No.: US 2019/0205829 A1
(43) Pub. Date: Jul. 4, 2019

(54) AUTOMATICALLY CLUSTERING SHIPPING UNITS AT DIFFERENT HIERARCHICAL LEVELS VIA MACHINE LEARNING MODELS

(71) Applicant: United Parcel Service of America, Inc., Atlanta, GA (US)

(72) Inventors: Ted Abebe, Jersey City, NJ (US); Ed Hojecki, Atlanta, GA (US); Colette Malyack, Atlanta, GA (US); Donald Hickey, Atlanta, GA (US)

(21) Appl. No.: 16/197,095

(22) Filed: Nov. 20, 2018

Related U.S. Application Data
(60) Provisional application No. 62/589,823, filed on Nov. 22, 2017.

(51) Int. Cl. G06Q 10/08; G06K 9/62; G06N 20/00

(52) U.S. Cl. CPC G06Q 10/0833; G06N 20/00; G06K 9/6223

(57) ABSTRACT

Embodiments are disclosed for autonomously clustering shipping units. An example method includes accessing clustering information units from a clustering data management tool. The example method further includes extracting features from clustering information units, wherein the features are representative of one or more of the shipper behavior data and the package information. Exemplary shipping units are shippers, buildings handling packages, package delivery drivers, and package handlers. The example method further includes generating, using a shipping unit clustering learning model and the features, an output comprising cluster of shipping units. Corresponding apparatuses and non-transitory computer readable storage media are also provided.

### CROSS-REFERENCE TO RELATED APPLICATIONS

This application claims priority to U.S. Provisional Patent Application No. 62/589,823 entitled “SYSTEMS AND METHODS FOR AUTOMATICALLY CLUSTERING SHIPPING UNITS AT DIFFERENT HIERARCHICAL LEVELS USING MACHINE LEARNING MODELS,” filed Nov. 22, 2017, which is incorporated herein by reference in its entirety.

### FIELD

The present disclosure relates to machine learning technology and clustering technology, and more particularly to using gathered clustering data and machine learning models to generate cluster of shipping units.

### BACKGROUND

When parcels (e.g., packages, containers, letters, items, pallets or the like) are received from shippers and transported from an origin to a destination, the process of transporting the packages may include moving the packages through various intermediate locations between its origin and destination, such as sorting operation facilities. Processing and sorting at these facilities may include various actions, such as culling where parcels are separated according to shape or other characteristics, capturing information from the parcel to retrieve shipping information (e.g., tracking number, destination address, etc.), organizing the parcels according to a shipment destination, and loading the parcels into a delivery vehicle. Efficiently allocating resources throughout the chain of delivery can be improved by identifying behavioral patterns of shippers or other entities accurately for some or each leg of the transportation process. For example, a customer may have historically provided a massive quantity of shipments to a carrier for shipment at the beginning of the week (e.g., Monday through Wednesday) over 90% of the time. Accordingly, by grouping or classifying the customer as an “early” shipper or “beginning-of-the-week” shipper, carriers may be able to allocate resources (e.g., make sure enough staff is present) at the beginning of each week to make sure that they can handle future incoming shipments from the customer.

Existing technologies are typically based on simple threshold-based calculation and require users to manually input various sets of information into computer systems to process shipments. For example, particular software applications require users to manually set the prediction parameters (e.g., how many packages will be arriving on a particular day) based on personal observation, such as viewing a spreadsheet to view pending shipments. In response to the manual entry in these computer systems, a display screen is configured to display the prediction for other users to view to adequately prepare for the prediction. Embodiments of the present disclosure improve these existing computer systems by overcoming various shortcomings, as described herein.

### SUMMARY

Example embodiments described herein comprise systems that autonomously clusters shipping units. The details of some embodiments of the subject matter described in this specification are set forth in the accompanying drawings and the description below. Other features, aspects, and advantages of the subject matter will become apparent from the description, the drawings, and the claims.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the invention in any way. It will be appreciated that the scope of the invention encompasses many potential embodiments in addition to those here summarized, some of which will be further described below.

### BRIEF DESCRIPTION OF FIG.S

Having thus described the disclosure in general terms, reference will now be made to the accompanying drawings, which are not necessarily drawn to scale, and wherein:

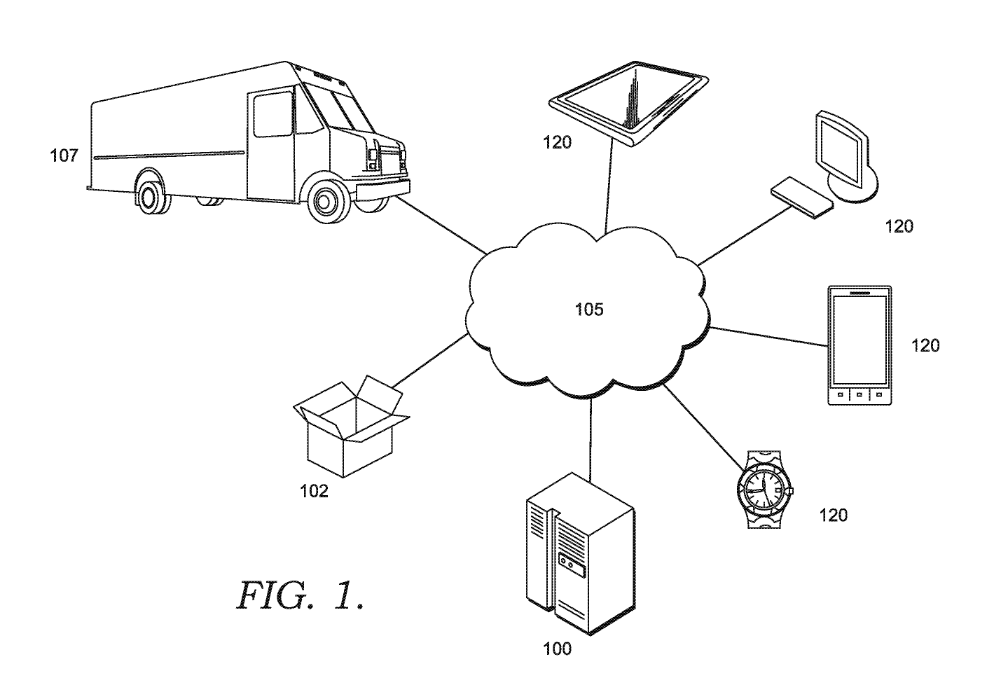

FIG. 1 provides an illustration of an exemplary embodiment of the present disclosure;

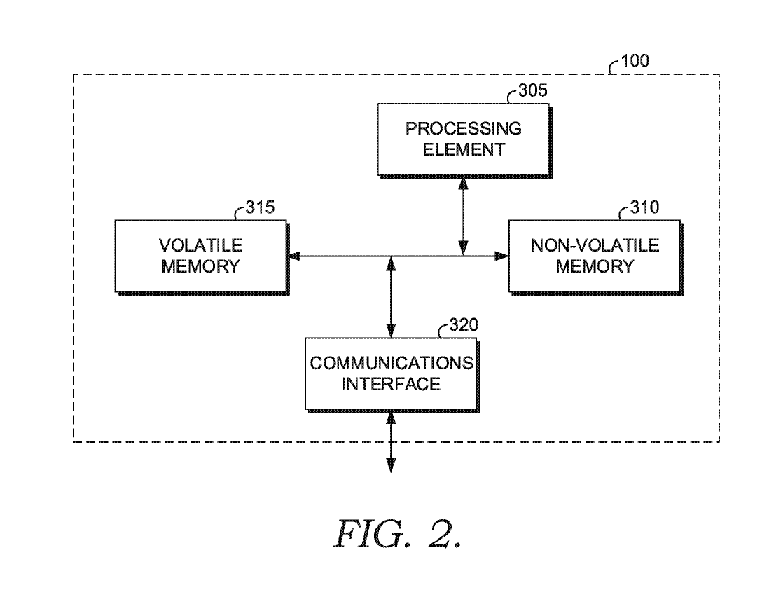

FIG. 2 provides a schematic of a clustering entity according to one embodiment of the present disclosure;

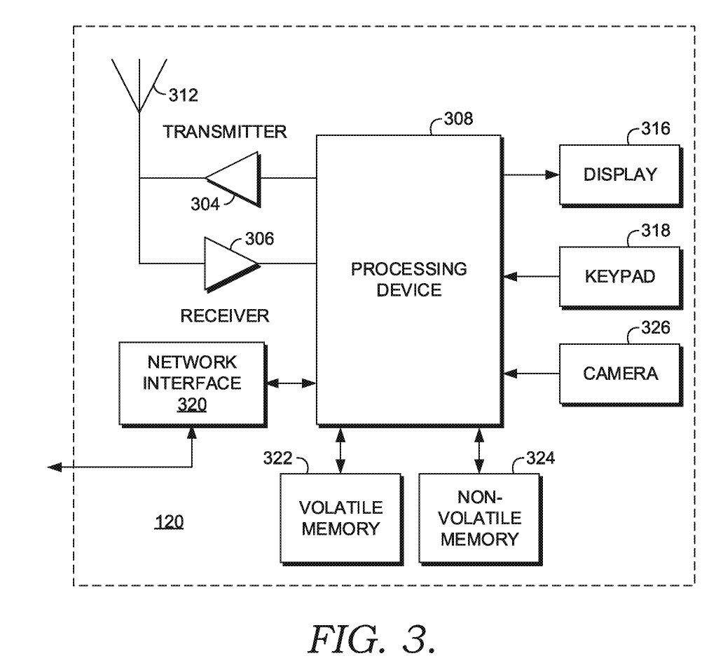

FIG. 3 provides an illustrative schematic representative of a mobile computing entity 120 that can be used in conjunction with embodiments of the present disclosure;

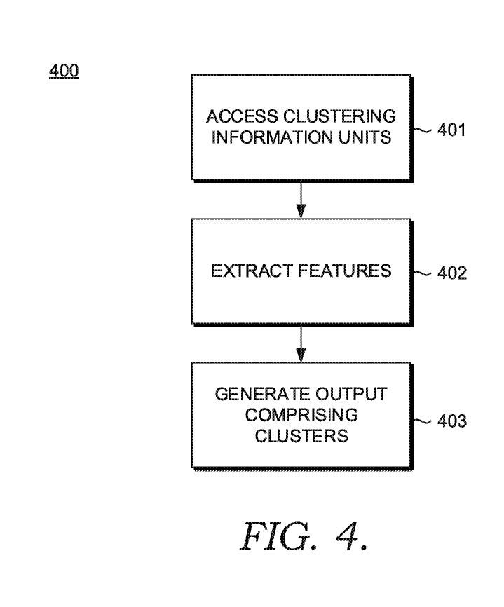

FIG. 4 illustrates an exemplary process for use with embodiments of the present disclosure;

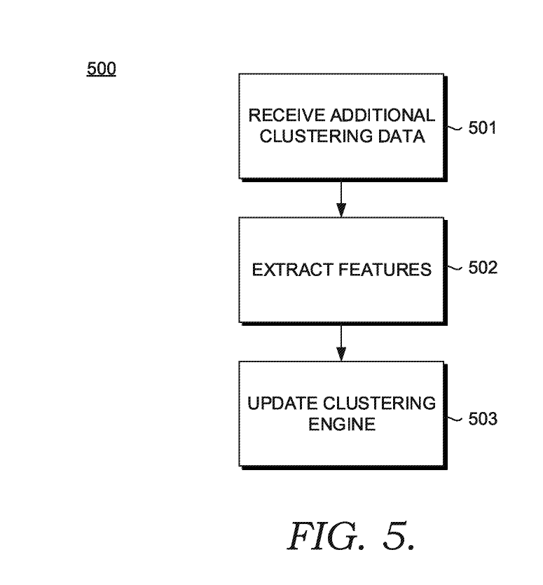

FIG. 5 illustrates an exemplary process for use with embodiments of the present disclosure;

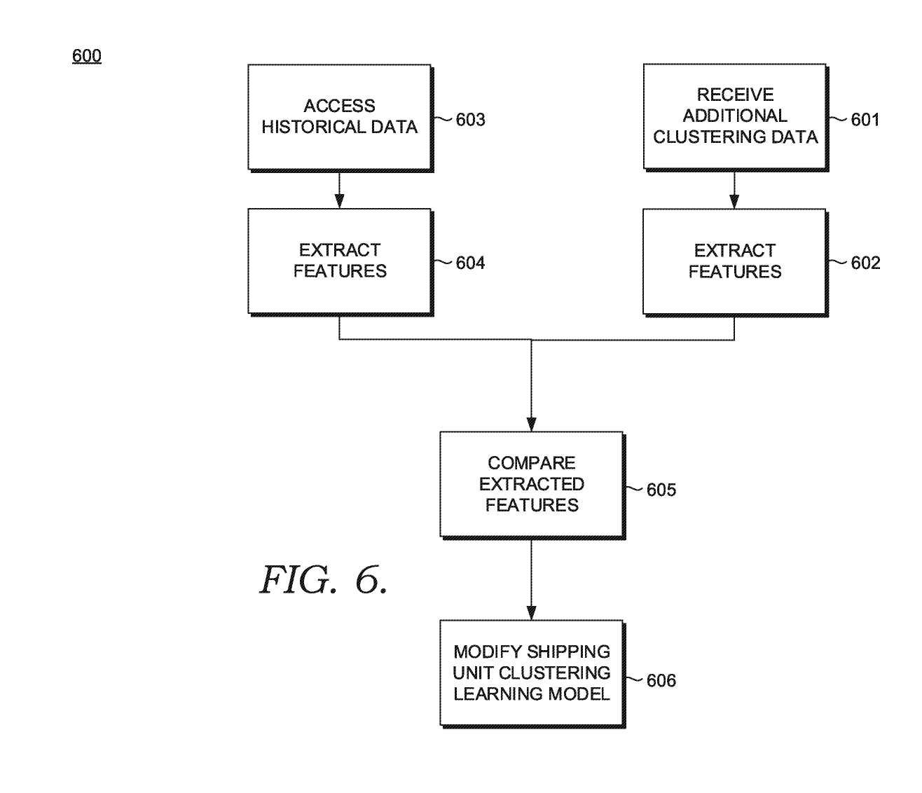

FIG. 6 illustrates an exemplary process for use with embodiments of the present disclosure;

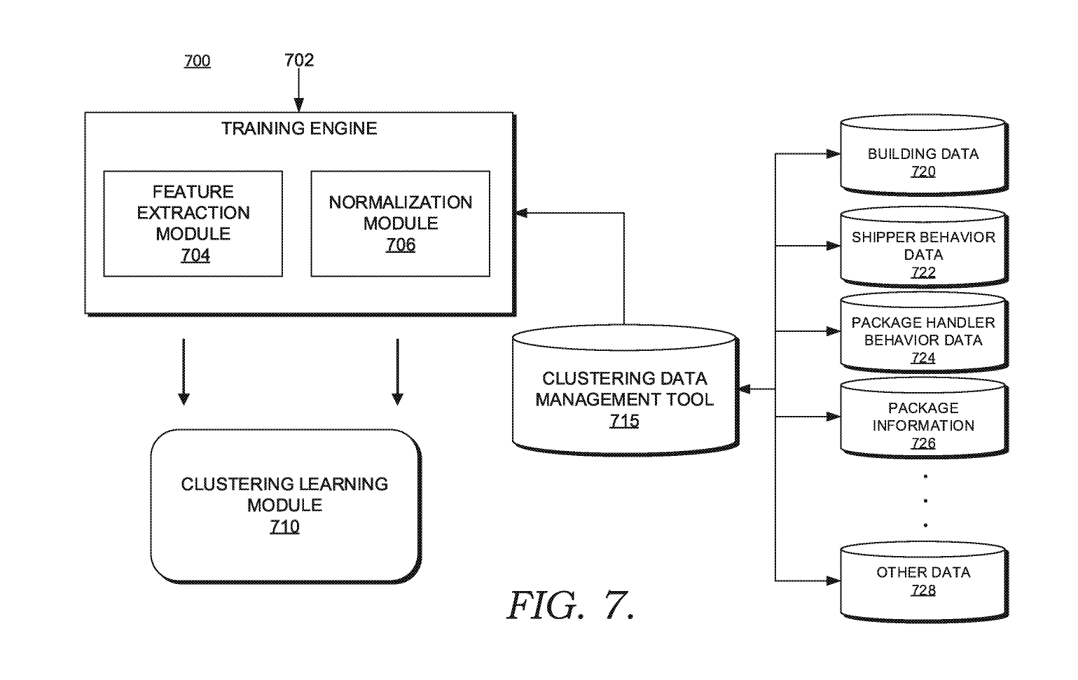

FIG. 7 is an example block diagram of example components of an example shipping unit clustering learning model training environment; and

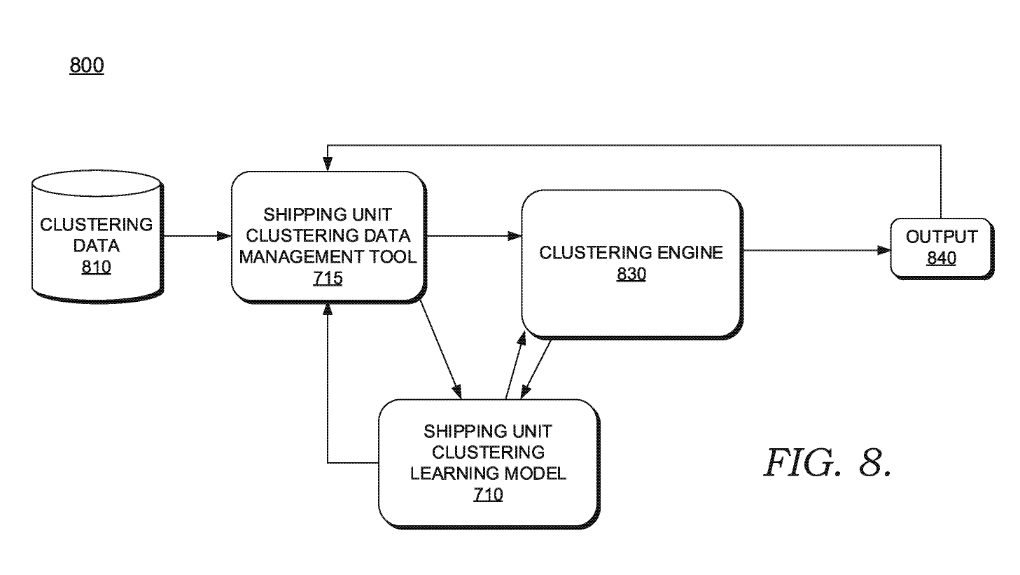

FIG. 8 is an example block diagram of example components of an example shipping unit clustering learning model service environment.

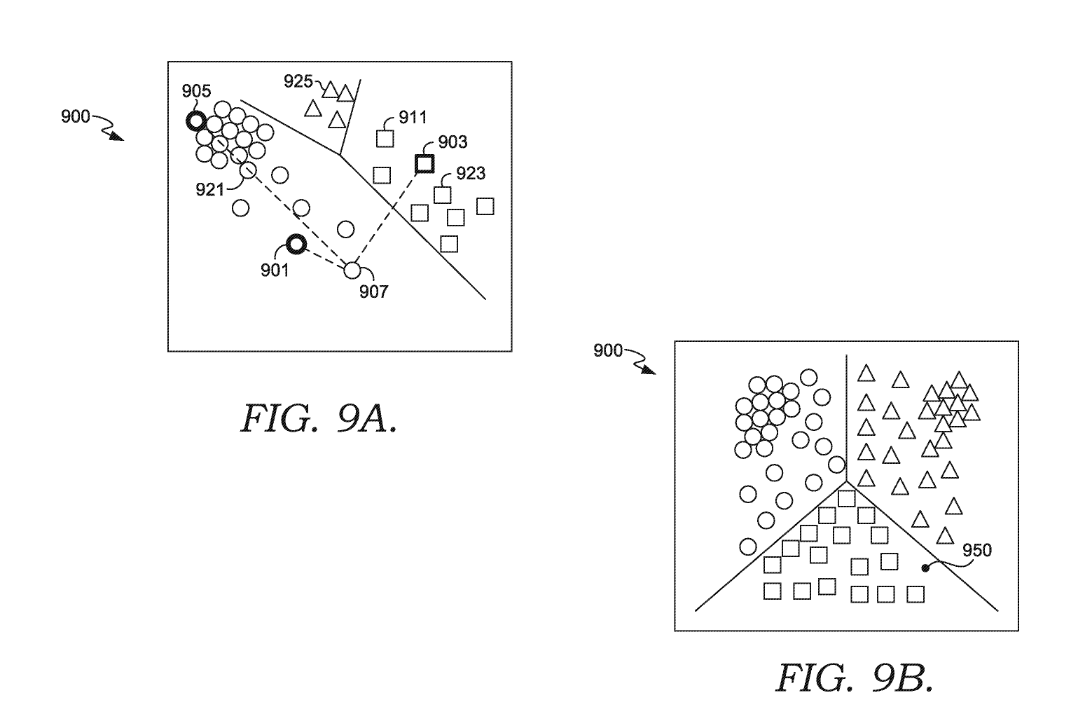

FIG. 9A is a schematic diagram of a scatter plot at a first time, according to particular embodiments.

FIG. 9B is a schematic diagram of the scatter plot at a second time subsequent to the first time illustrated in FIG. 9A, according to particular embodiments.

### DETAILED DESCRIPTION

The present disclosure will now be described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. Like numbers refer to like elements throughout.

### I. Overview

Existing computing system technologies employ functionality that predicts shipper or other entity behavior based on simple threshold-based calculations. For example, existing technologies may predict that there will be 1,000 packages coming into one facility in the next five days, but does not automatically cluster shippers (e.g., as accurate or not accurate in data entry) or other entities (e.g., drivers, shipping facilities, etc.). This would give more information and accuracy about the 1,000 packages arriving in order to allocate resources for the incoming packages. Moreover, existing technologies do not output hierarchical level information such as the service types of the packages that will be received, what times during the day the packages will be received, etc.

Existing computing system technologies also employ functionality that require users to manually input repetitive information. For example, users may be required to manually enter several values from a package manifest into an electronic spreadsheet application, which then does simple threshold-based calculations. Further, particular computer systems require users to manually select or enter a category or domain that a shipper belongs to, such that a graphical user interface associates the category or domain with the shipper. However, not only does this waste valuable time, but various computing resources are unnecessarily consumed. For example, repetitive clicks, selections, or manual data entry in these systems increase storage device I/O (e.g., excess physical read/write head movements on non-volatile disk). This is because each time a user inputs this information (e.g., 30 values from a package manifest), the computing system has to traverse a network and reach out to a storage device to perform a read or write operation. This is time consuming, error prone, and can eventually wear on components, such as a read/write head. Reaching out to disk is also very expensive because of the address location identification time and mechanical movements required of a read/write head. Further, when users repetitively issue queries, it is expensive because processing multiple queries consume a lot of computing resources. For example, an optimizer engine of a database manager module calculates a query execution plan (e.g., calculates cardinality, selectivity, etc.) each time a query to locate staff details (e.g., work shift, who is available to work, etc.) is issued to make forecasting predictions. This requires a database manager to find the least expensive query execution plan to fully execute the query. Most database relations contain hundreds if not thousands of records. Repetitively calculating query execution plans on this quantity of records decreases throughput and increases network latency. Moreover, manual data entry is particularly tedious and can be error prone. For example, in various instances users input the wrong information, which causes errors.

Various embodiments of the present disclosure improve these existing computer technologies via new functionalities that these existing technologies or computing systems do not now employ. For example, various embodiments of the present disclosure improve the accuracy of existing prediction technologies by clustering shippers or other entities at multiple different hierarchical levels to thereby enable more targeted predictive resource allocation. As described above, typical application technologies for prediction do not automatically cluster shippers, which leads to an inability to allocate resources (e.g., provide extra staff on a particular day because of a staffing shortage on a particular day). Through applied effort, ingenuity, and innovation, this and other problems have been solved by embodiments of the present disclosure, many examples of which are described in detail herein. By accessing one or more clustering information units or other data (e.g., parcel received time, manifest package time, dimension information, etc.), feeding this information through a shipping unit clustering learning model, and responsively making a prediction or cluster (e.g., clustering various shippers as only shipping in a particular set of months), the improved computer systems in particular embodiments are able to more fully and accurately make predictions associated with shipments, as described in more detail herein (e.g., FIG. 4 through FIG. 10).

Some embodiments also improve existing software technologies by automating tasks (e.g., automatically accessing information and automatically clustering or generating an output comprising cluster shipping units) via certain rules (e.g., accessing one or more volume information units or volume forecast data). As described above, such tasks are not automated in various existing technologies and have only been historically performed by manual computer input by humans. In particular embodiments, incorporating these certain rules improve existing technological processes by allowing the automation of these certain tasks, which is described in more detail below. For example, as stated above, certain existing computer systems require users to manually select or enter a category or domain that a shipper belongs to (e.g., a “timely” shipper). In various embodiments, the manual selection or entering of such category or domain in typical computer applications is replaced by automatically clustering (e.g., shippers or other entities) or automatically generating an output comprising one or more clusters of shipping units, which performs much more functionality than mere selection of a category or domain, as described herein.

Various embodiments improve resource consumption in computing systems (e.g., disk I/O). Particular embodiments selectively exclude or do not require a request for a user to manually enter information, such as carrier personnel entering prediction values based on personal observation of package manifests. Because users do not have to keep manually entering information or selections, storage device I/O is reduced and query optimizers are not as often utilized, which allows for a reduction in computing query execution plans and thus increased throughput and decreased network latency. For example in particular embodiments, as soon as package manifest information is received from a user, some or each of the information in the package manifest information is parsed and written to disk a single time (as opposed to multiple times for each set of information) when it is fed through learning models and predictions are made. Accordingly, the disk read/write head in various embodiments reduces the quantity of times it has to go to disk to write records, which may reduce the likelihood of read errors and breakage of the read/write head.

### II. Computer Program Products, Methods, and Computing Entities

Embodiments of the present disclosure may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double information/data rate synchronous dynamic random access memory (DDR SDRAM), double information/data rate type two synchronous dynamic random access memory (DDR2 SDRAM), double information/data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present disclosure may also be implemented as methods, apparatus, systems, computing devices/entities, computing entities, and/or the like. As such, embodiments of the present disclosure may take the form of an apparatus, system, computing device, computing entity, and/or the like executing instructions stored on a computer-readable storage medium to perform certain steps or operations. However, embodiments of the present disclosure may also take the form of an entirely hardware embodiment performing certain steps or operations.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### III. Example Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices/entities, such as, for example, one or more servers, relays, routers, network access points, base stations, hosts, and/or the like, sometimes referred to herein as a “network.” Similarly, where a computing device is described herein to transmit data to another computing device, it will be appreciated that the data may be sent directly to another computing device or may be sent indirectly via one or more intermediary computing devices/entities, such as, for example, one or more servers, relays, routers, network access points, base stations, hosts, and/or the like.

The terms “package”, “parcel, “item,” and/or “shipment” refer to any tangible and/or physical object, such as a wrapped package, a container, a load, a crate, items banded together, an envelope, suitcases, vehicle parts, pallets, drums, vehicles, and the like sent through a delivery service from a first geographical location (e.g., a first address) to one or more other geographical locations (e.g., a second address).

The term “carrier” and/or “shipping service provider” (used interchangeably) refer to a traditional or nontraditional carrier/shipping service provider. A carrier/shipping service provider may be a traditional carrier/shipping service provider, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. A carrier/shipping service provider may also be a nontraditional carrier/shipping service provider, such as Amazon, Google, Uber, ride-sharing services, crowd-sourcing services, retailers, and/or the like.

The term “shipping unit” refers to an entity associated with the process of shipping. For example, shipping unit comprises one or more shippers, package handlers, buildings, package delivery drivers, and/or the like.

The term “clustering data” refers to data of interest for clustering shipping units. In some embodiments, the clustering data comprises one or more package received time (e.g., the actual time one or more packages are received at a sorting operation facility), manifest package time, package information such as tracking number, package activity time stamp, package dimension including height, length and/or width, package weight, package manifested weight (e.g., the weight of a parcel as indicated in a package manifest), package manifest time stamp (e.g., the time at which a package manifest is uploaded), package service type, package scanned time stamp (e.g., the time at which a parcel was scanned to capture parcel information data), package tracking number, package sort type code, package scanned code (e.g., a barcode), unit load device type code, account number associated with the package, and the like. In some embodiments, clustering data may be received from vehicles or mobile computing entities. A “unit load device type code” identifies an entity type in which one or more parcels are loaded into for delivery, such as a container, a delivery vehicle, a bag, a pallet, etc.

The term “clustering data management tool” refers to a management tool that collects and manages clustering data. The clustering data may be provided over a computer network and to the clustering data management tool by one or more different service points (e.g., lockers, carrier stores, retailers, etc.), vehicles, mobile computing entities, and any other electronic devices that gather clustering data. Alternatively or in addition, the clustering data management tool may receive clustering data directly from a distributed computing entity. In some embodiments, the clustering data management tool is embedded within a clustering entity, such as a program that clusters shippers or other entities.

The term “clustering information units” refers to a set of data that has been normalized (e.g., via Z-score, min max, etc.) and parsed within a larger pool of clustering data. The process of parsing the clustering data may comprise selectively copying clustering data based on the tuning of a shipping unit clustering learning model. To selectively copy or extract clustering data means that only some data is extracted or copied from the clustering data to be fed through a learning model, while another set of data is not extracted or copied and is not fed through a learning model. For instance, in some embodiments, a person's name in manifest package information is not extracted because this clustering data would not necessarily be needed by the shipping unit clustering learning model. However, other information, such as manifest weight, dimensions, etc. would be used to make predictions. The clustering information units in such instances refer to the subset of clustering data that does not contain those certain elements of the clustering data, and the parsing and normalization process eliminates those certain elements prior to the remaining data being fed into the shipping unit clustering learning model.

In some embodiments, clustering information units comprises data that has been pre-processed by another machine learning model, such as different shipping unit behavior data generated by various different shipping unit behavior learning models. Example shipping unit behavior data includes shipper behavior data (e.g., predictions indicating what the shipper is likely to ship based on what the shipper typically ships, when the shipper will likely ship based on when the shipper typically ships, and/or where the shipper will likely ship based on where the shipper typically ships), building volume data (e.g., predictions indicating how many packages will likely arrive at a particular building based on how many packages have historically arrived), package handler behavior data (e.g., predictions indicating what kind of parcel the package handler will likely receive based on the kinds of parcels the package handler typically receives), package delivery driver behavior data (e.g., predictions indicating what/when/where the driver will likely deliver to based on what/when/where the driver has historically delivered to), and the like.

The following illustrations are examples of various shipping unit behavior data. For example, shipper behavior data can include predictions about whether a shipper will likely be accurate (e.g., provides corrects address, zip code, other package manifest information) based on the shipper historically being accurate or not. In another example, package handler behavior data can include predictions about whether a package handler facility will likely be accurate (e.g., predicts the correct quantity of inbound volume, predicts the correct quantity of workers needed, etc.) based on the facility historically being accurate or not. In yet another example, delivery driver behavior data can include predictions about whether a driver drives accurately (e.g., provides parcels to the correct addresses, following driving protocols/law, avoids accidents, etc.) based on the driver historically being accurate in driving or not. In another example, shipping unit behavior data can include predicting whether one or more shipments will likely be associated with a particular industry segment based on the industry segment(s) associated with prior shipments. For example, 90% of past shipments from shipper X, may be categorized under the software industry. In yet another example, shipping unit behavior data may include predictions about when various seasons are the busiest (e.g., the quantity of shipments received are relatively higher) based on past seasonal data. In yet another example of package handler behavior data, the data may include a prediction of whether the weather will affect any of the other shipping unit behavior data cases based on historical weather patterns. In yet another example of package handler behavior data, it may be predicted whether a particular sort facility or instance of a sort facility will be a bottleneck (e.g., will take longer to process than usual) based on a history of the facility or instance being a bottleneck.

The term “feature” refer to data generated based on clustering information units and that is subsequently fed into a machine learning model. In some embodiments, the features are equivalent to clustering information units (i.e., they are the same). Alternatively or in addition, the features can be generated by other techniques, such as classifying or categorizing information. For example, if the clustering information unit comprises “manifest time: 9:00 am; received time: 10:04 am; package weight: 30 lb”, the features generated can be based on categorization of each of the elements present in the clustering information unit in the form of “manifest time: morning; received time: morning; package weight: heavy”. Accordingly, the features would be “morning, morning, and heavy” for the specific corresponding values. In some embodiments, one feature may be generated based on multiple clustering information units. For example, package received time for multiple occasions can be used to generate one feature. A clustering engine may use clustering information units that represents package manifest time and package received time in the past two months and generate a feature called “percentage of early manifests in the past two months”. Moreover, features can be generated based on pre-processed clustering information units, for example, pre-processed clustering information units that indicates shipping unit behavior, may be extracted to generate features.

The term “package manifest” refers to a report (e.g., a digital document) provided by a shipper to a shipping service provider that summarizes the shipment information about one or more parcels that the shipper is going to provide to the shipping service provider. A package manifest may include one or more of: the shipper's account information, shipping record identifier, dimensions of the package to be picked up, a planned package pick up time, a package pick up location, package weight, tracking number, manifest time stamp (e.g., day of week, month, week, and/or hour that the manifest is uploaded), service type code, and the like. A package manifest may contain any of the information described in the present disclosure.

The term “manifest package time” refers to the planned package pick up time in the package manifest. For example, a shipper may request that a shipping service provider send a driver to pick up a package at a certain location (manifest package location) at a manifest package time by selecting or inputting the time in a manifest package time field of the package manifest.

The term “package timeliness” refers to a shipper's timeliness in providing the shipper's package to a shipping service provider with respect to the manifest package time. For example, a shipper may indicate that the shipper is going to provide a package to the service provider on 2:00 pm on Thursday, and if the shipper provides the shipping service provider with the package at 2:00 pm on Thursday, then the shipper would be categorized as a “timely shipper” with respect to that package. In some embodiments, providing the package within a certain window before or after 2:00 pm on Thursday would still result in the shipper being categorized as a timely shipper. However, if the shipper provides the package late by a certain predefined amount of time, the shipper would be categorized as a “late shipper” in some embodiments. And if the shipper provides the package early by a certain predefined amount of time, then the shipper would be categorized as an “early shipper” in some embodiments.

The term “package received time” refers to the actual time where the package is received by a shipping service provider from a shipper. For example, the package received time may be when carrier personnel at a shipping store print out a label for a package that a shipper has brought to the shipping store.

The term “indicator” refers to data that indicates certain attributes. For example, a residential indicator indicates whether a package is being sent to residential address, a hazardous material indicator indicates whether a package contains hazardous material, an oversize indicator indicates whether a package is oversized, a document indicator indicates whether a package is a document, and a Saturday delivery indicator indicates whether a package is planned to be delivered on a Saturday. In some embodiments, indicators are generated in response to receiving and analyzing information in one or more package manifests and mapping the indicator to an attribute (e.g., via a hash table).

The term “package activity time stamp” refers to a time stamp generated based on the time-stamp data acquired when performing package activities. Package activity time stamps are indicative of times (e.g., clock-times) at which one or more parcels are received and/or transmitted to/from one or more locations. For example, a package time activity time stamp may be one or more of the following: a time stamp generated when the package is received from the shipper, a time stamp generated when the package is sent from a receiving site to an intermediate transmit vehicle, a time stamp generated when the package is sent from an intermediate transmit vehicle to another vehicle, and the like.

The term “building type” refers to the categorization of a building operated by a shipping service provider. For example, buildings may be categorized by size, average inbound and/or outbound volume, location, purpose of the building (intermediate transit or stores facing customers, etc.,) and the like.

The term “service type” or “package service type” refers to the categorization of the service provided associated with the package. For example, service type may be categorized by delivery speed, return receipt requested, insurance associated with the package, originating location, destination location, and the like. Exemplary service types include “Next Day Air”, “2^{nd} day Air”, “Worldwide Express”, “Standard”, and the like. In some embodiments, the service type is indicated in a package manifest.

The term “sort type” or “package sort type code” refers to the categorization of time in hours/minutes of package received time. An exemplary way of defining sort type is provided as the following:
Package receive between 10:00 pm and 5:00 am: Sort type “Late night”;
Package receive between 5:00 am and 8:00 am: Sort type “Early Morning”;
Package receive between 8:00 am and 2:00 pm: Sort type “Morning to early afternoon”;
Package receive between 2:00 pm and 10:00 am: Sort type “Afternoon to Night”.

Packages can be categorized by sort types defined using different names and different defined time period. Each defined category is called a “sort”. In some embodiments, sorts are generated in response to receiving and analyzing information in one or more package manifests and mapping package received times to the sort type (e.g., via a data structure). In some embodiments, sorts are generated in response to running package manifest information through a learning model (e.g., a word embedding vector model)

The term “account type” refers to the categorization of the shipper account associated with a package. For example, account type may be categorized by whether the shipper is a personal shipper or a business shipper, by the frequency with which the shipper provides packages, by the service type requested, or by other shipping information associated with an account of the shipper. The shipping information may be processed before being used to categorize account type. For example, if a personal shipper ships ten packages per month, a server may first process the shipping information associated with the ten packages and generate an indicator of frequency of shipping for the shipper, then categorize the shipper's account type as “frequent—personal shipper”. In some embodiments, account types are generated in response to receiving and analyzing information in one or more package manifests and mapping information to an account type. In some embodiments, sorts are generated in response to running package manifest information through a learning model.

The term “hierarchical level” refers to a categorization of information. For example, volume forecast or actual volume information (e.g., quantity of packages received) can be generated for the hierarchical level of account plus building, which means that the volume forecast or actual volume information reflects package volume associated with a certain type of account (such as personal shipper account) at a particular building (such as operational facility at 123 Fictional Street). Hierarchical levels can reflect one or more of: account type, service type, building type, sort type, building identifier (such as building address or id code), package weight category, package dimension category, other categorizations of packages, shipper, or facilities in the shipping process, and the like. In some embodiments, volume forecast or actual volume information are generated at a certain hierarchical level by extracting features for a certain hierarchical level. For example, if volume forecast at hierarchal level building plus sort is desired (e.g., package volume forecast for a building during early morning); features extracted may reflect previous package information at the particular building and sort type. Moreover, hierarchical levels can be used to categorize other shipping unit information such as shipper behavior, package handler behavior, package delivery driver behavior, and the like. In various embodiments, shippers and/or other entities can be clustered within one or more hierarchical levels. For example, for a “package weight category” hierarchical level, shippers can be clustered into whether the shipper typically ships “heavy” (cluster 1) or “light” (cluster 2) parcels.

The term “hierarchical level information” refers to information describing a hierarchical level. Hierarchical level information comprises one or more of: account type, service type, building type, sort type, building identifier, package weight category, package dimension category, other categorizations of packages, shipper, or facilities in the shipping process, and the like.

The term “shipping unit clustering learning model” refers to a machine learning model that uses features generated from clustering information units to generate a cluster of a set of shipping units (e.g., at various hierarchical levels).

A “machine learning model” or “learning model” as described herein refers to a model that is used for machine learning tasks or operations. A machine learning model can comprise a title and encompass one or more input images or data, target variables, layers, classifiers, etc. In various embodiments, a machine learning model can receive an input (e.g., package manifest information and/or actual processed information (e.g., actual received date, etc.)), identify patterns or associations in the input in order to predict a given output (e.g., cluster a user into a group (e.g., a non-accurate shipper) and make predictions based on the category (e.g., the user's future shipments will not be accurate)). Machine learning models can be or include any suitable model, such as one or more: k-means clustering model, neural networks, word2Vec models, Bayesian networks, Random Forests, Boosted Trees, etc. “Machine learning” as described herein, in particular embodiments, corresponds to algorithms that parse or extract features of historical data (e.g., package manifests/past shipments), learn (e.g., via training) about the historical data by making observations or identifying patterns in data, and then receive a subsequent input (e.g., a current set of package manifests) in order to make a determination, prediction, and/or classification of the subsequent input based on the learning without relying on rules-based programming (e.g., conditional statement rules).

### IV. Exemplary System Architecture

FIG. 1 provides an illustration of an exemplary embodiment of the present invention. As shown in FIG. 1, this particular embodiment may include one or more clustering entities 100 that each comprise a clustering engine, one or more package/items/shipments 102, one or more networks 105, one or more vehicles 107, one or more mobile computing entities 120, and/or the like. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Clustering Entity

FIG. 2 provides a schematic of a clustering entity 100 according to one embodiment of the present invention. The clustering entity 100 may comprise clustering data management tool and clustering engine among other modules. In certain embodiments, the clustering entity 100 may be maintained by and/or accessible by a carrier. A carrier may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, retailers, and/or the like. In general, the terms computing entity, computer, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the clustering entity 100 may also include one or more communications interfaces 220 for communicating with various computing entities, such as by communicating data, content, information, and/or similar terms used herein interchangeably that can be transmitted, received, operated on, processed, displayed, stored, and/or the like.

As shown in FIG. 2, in one embodiment, the clustering entity 100 may include or be in communication with one or more processing elements 305 (also referred to as processors, processing circuitry, processing devices, and/or similar terms used herein interchangeably) that communicate with other elements within the clustering entity 100 via a bus, for example. As will be understood, the processing element 305 may be embodied in a number of different ways. For example, the processing element 305 may be embodied as one or more complex programmable logic devices (CPLDs), microprocessors, multi-core processors, coprocessing entities, application-specific instruction-set processors (ASIPs), microcontrollers, and/or controllers. Further, the processing element 305 may be embodied as one or more other processing devices or circuitry. The term circuitry may refer to an entirely hardware embodiment or a combination of hardware and computer program products. Thus, the processing element 305 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 305 may be configured for a particular use or configured to execute instructions stored in volatile or non-volatile media or otherwise accessible to the processing element 305. As such, whether configured by hardware or computer program products, or by a combination thereof, the processing element 305 may be capable of performing steps or operations according to embodiments of the present invention when configured accordingly. For example, processing element may be configured to perform various functionality of a clustering engine, such as

In one embodiment, the clustering entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 310, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The terms database, database instance, database management system, and/or similar terms used herein interchangeably may refer to a structured collection of records or data that is stored in a computer-readable storage medium, such as via a relational database, hierarchical database, hierarchical database model, network model, relational model, entity—relationship model, object model, document model, semantic model, graph model, and/or the like.

In one embodiment, the clustering entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 305. Thus, the databases, database instances, database management systems, data, applications, programs, program modules, scripts, source code, object code, byte code, compiled code, interpreted code, machine code, executable instructions, and/or the like may be used to control certain aspects of the operation of the clustering entity 100 with the assistance of the processing element 305 and operating system.

As indicated, in one embodiment, the clustering entity 100 may also include one or more communications interfaces 320 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the clustering entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Bluetooth protocols, Wibree, Home Radio Frequency (HomeRF), Simple Wireless Abstract Protocol (SWAP), wireless universal serial bus (USB) protocols, and/or any other wireless protocol.

Although not shown, the clustering entity 100 may include or be in communication with one or more input elements, such as a keyboard input, a mouse input, a touch screen/display input, motion input, movement input, audio input, pointing device input, joystick input, keypad input, and/or the like. The clustering entity 100 may also include or be in communication with one or more output elements (not shown), such as audio output, video output, screen/display output, motion output, movement output, and/or the like.

In some embodiments, processing element 305, non-volatile memory 310 and volatile memory 315 may be configured to support a clustering engine. For example, processing element 305 may be configured to execute operations that comprise the clustering engine, and non-volatile memory 310 and volatile memory 315 may be configured to store computer code executed by the processing element 305, as well as to store relevant intermediate or ultimate results produced from execution of the clustering engine.

In some embodiments, processing element 305, non-volatile memory 310 and volatile memory 315 may be configured to support a clustering data management tool. For example, processing element 305 may be configured to execute operations that comprise the clustering data management tool, and non-volatile memory 310 and volatile memory 315 may be configured to store computer code executed by the processing element 305, as well as to store relevant intermediate or ultimate results produced from execution of the clustering data management tool.

As will be appreciated, one or more of the clustering entity's 100 components may be located remotely from other clustering entity 100 components, such as in a distributed system. Furthermore, one or more of the components may be combined and additional components performing functions described herein may be included in the clustering entity 100. Thus, the clustering entity 100 can be adapted to accommodate a variety of needs and circumstances. As will be recognized, these architectures and descriptions are provided for exemplary purposes only and are not limited to the various embodiments.

### 2. Exemplary Vehicle

In various embodiments, the term vehicle 107 is used generically. For example, a carrier/transporter vehicle 107 may be a manned or unmanned tractor, a truck, a car, a motorcycle, a moped, a Segway, a bicycle, a golf cart, a hand truck, a cart, a trailer, a tractor and trailer combination, a van, a flatbed truck, a vehicle, an unmanned aerial vehicle (UAV) (e.g., a drone), an airplane, a helicopter, a boat, a barge, and/or any other form of object for moving or transporting people and/or package/items/shipments (e.g., one or more packages, parcels, bags, containers, loads, crates, items banded together, vehicle parts, pallets, drums, the like, and/or similar words used herein interchangeably). In one embodiment, each vehicle 107 may be associated with a unique vehicle identifier (such as a vehicle ID) that uniquely identifies the vehicle 107. The unique vehicle ID (e.g., trailer ID, tractor ID, vehicle ID, and/or the like) may include characters, such as numbers, letters, symbols, and/or the like. For example, an alpha, numeric, or alphanumeric vehicle ID (e.g., “AS”) may be associated with each vehicle 107. In another embodiment, the unique vehicle ID may be the license plate, registration number, or other identifying information/data assigned to the vehicle 107. As noted above, in instances where the vehicle is a carrier vehicle, the vehicle may be a self-driving delivery vehicle or the like. Thus, for the purpose of the present disclosure, the term driver of a delivery vehicle may be used to refer to a carrier personnel who drives a delivery vehicle and/or delivers package/items/shipments therefrom, an autonomous system configured to deliver package/items/shipments (e.g., a robot configured to transport package/items/shipments from a vehicle to a service point such as a customer's front door or other service point), and/or the like.

Various computing entities, devices, and/or similar words used herein interchangeably can be associated with the vehicle 107, such as a data collection device or other computing entities. In general, the terms computing entity, entity, device, system, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, iBeacons, proximity beacons, key fobs, RFID tags, ear pieces, scanners, televisions, dongles, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. The data collection device may collect telematics information/data (including location information/data) and transmit/send the information/data to an onboard computing entity, a distributed computing entity, and/or various other computing entities via one of several communication methods.

In one embodiment, the data collection device may include, be associated with, or be in wired or wireless communication with one or more processors (various exemplary processors are described in greater detail below), one or more location-determining devices or one or more location sensors (e.g., Global Navigation Satellite System (GNSS) sensors), one or more telematics sensors, one or more real-time clocks, a J-Bus protocol architecture, one or more electronic control modules (ECM), one or more communication ports for receiving telematics information/data from various sensors (e.g., via a CAN-bus), one or more communication ports for transmitting/sending information/data, one or more RFID tags/sensors, one or more power sources, one or more data radios for communication with a variety of communication networks, one or more memory modules 410, and one or more programmable logic controllers (PLC). It should be noted that many of these components may be located in the vehicle 107 but external to the data collection device.

In one embodiment, the one or more location sensors, modules, or similar words used herein interchangeably may be one of several components in wired or wireless communication with or available to the data collection device. Moreover, the one or more location sensors may be compatible with GPS satellites, such as Low Earth Orbit (LEO) satellite systems, Department of Defense (DOD) satellite systems, the European Union Galileo positioning systems, Global Navigation Satellite systems (GLONASS), the Chinese Compass navigation systems, Indian Regional Navigational satellite systems, and/or the like. Furthermore, the one or more location sensors may be compatible with Assisted GPS (A-GPS) for quick time to first fix and jump start the ability of the location sensors to acquire location almanac and ephemeris data, and/or be compatible with Satellite Based Augmentation System (SBAS) such as Wide Area Augmentation System (WAAS), European Geostationary Navigation Overlay Service (EGNOS), and/or MTSAT Satellite Augmentation System (MSAS), GPS Aided GEO Augmented Navigation (GAGAN) to increase GPS accuracy. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, triangulation may be used in connection with a device associated with a particular vehicle 107 and/or the vehicle's operator and with various communication points (e.g., cellular towers or Wi-Fi access points) positioned at various locations throughout a geographic area to monitor the location of the vehicle 107 and/or its operator. The one or more location sensors may be used to receive latitude, longitude, altitude, heading or direction, geocode, course, position, time, and/or speed data (e.g., referred to herein as telematics information/data and further described herein below). The one or more location sensors may also communicate with the clustering entity, the data collection device, distributed computing entity, m computing entity, and/or similar computing entities.

As indicated, in addition to the one or more location sensors, the data collection device may include and/or be associated with one or more telematics sensors, modules, and/or similar words used herein interchangeably. For example, the telematics sensors may include vehicle sensors, such as engine, fuel, odometer, hubometer, tire pressure, location, weight, emissions, door, and speed sensors. The telematics information/data may include, but is not limited to, speed data, emissions data, RPM data, tire pressure data, oil pressure data, seat belt usage data, distance data, fuel data, idle data, and/or the like (e.g., referred to herein as telematics information/data). The telematics sensors may include environmental sensors, such as air quality sensors, temperature sensors, and/or the like. Thus, the telematics information/data may also include carbon monoxide (CO), nitrogen oxides (NOx), sulfur oxides (SOx), Ethylene Oxide (EtO), ozone (O₃), hydrogen sulfide (H₂S) and/or ammonium (NH₄) data, and/or meteorological data (e.g., referred to herein as telematics information/data).

In one embodiment, the ECM may be one of several components in communication with and/or available to the data collection device. The ECM, which may be a scalable and subservient device to the data collection device, may have data processing capability to decode and store analog and digital inputs from vehicle systems and sensors. The ECM may further have data processing capability to collect and present telematics information/data to the J-Bus (which may allow transmission to the data collection device), and output standard vehicle diagnostic codes when received from a vehicle's J-Bus-compatible on-board controllers 440 and/or sensors.

As indicated, a communication port may be one of several components available in the data collection device (or be in or as a separate computing entity). Embodiments of the communication port may include an Infrared Data Association (IrDA) communication port, a data radio, and/or a serial port. The communication port may receive instructions for the data collection device. These instructions may be specific to the vehicle 107 in which the data collection device is installed, specific to the geographic area in which the vehicle 107 will be traveling, specific to the function the vehicle 107 serves within a fleet, and/or the like. In one embodiment, the data radio may be configured to communicate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, WiMAX, UWB, IR, NFC, Bluetooth, USB, Wibree, HomeRF, SWAP, and/or the like.

### 3. Exemplary Package/Item/Shipment

A package/item/shipment 102 may be any tangible and/or physical object. Such items/shipments 102 may be picked up and/or delivered by a carrier/transporter. In one embodiment, an package/item/shipment 102 may be or be enclosed in one or more packages, parcels, bags, containers, loads, crates, items banded together, vehicle parts, pallets, drums, the like, and/or similar words used herein interchangeably. Such items/shipments 102 may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. For example, the package/item/shipment 102 may be configured to communicate with a mobile computing entity 120 using a short/long range communication technology, as described in more detail below. Further, such package/items/shipments 102 may have the capabilities and components of the described with regard to the clustering entities 100, networks 105, vehicles 107, mobile computing entities 120, and/or the like. For example, the package/item/shipment 102 may be configured to store package/item/shipment information/data. In example embodiments, the package/item/shipment information/data may comprise one or more of a consignee name/identifier, an package/item/shipment identifier, a service point (e.g., delivery location/address, pick-up location/address), instructions for delivering the package/item/shipment, and/or the like. In this regard, in some example embodiments, a package/item/shipment may communicate send “to” address information/data, received “from” address information/data, unique identifier codes, and/or various other information/data. In one embodiment, each package/item/shipment may include a package/item/shipment identifier, such as an alphanumeric identifier. Such package/item/shipment identifiers may be represented as text, barcodes, tags, character strings, Aztec Codes, MaxiCodes, Data Matrices, Quick Response (QR) Codes, electronic representations, and/or the like. A unique package/item/shipment identifier (e.g., 123456789) may be used by the carrier to identify and track the package/item/shipment as it moves through the carrier's transportation network. Further, such package/item/shipment identifiers can be affixed to items/shipments by, for example, using a sticker (e.g., label) with the unique package/item/shipment identifier printed thereon (in human and/or machine readable form) or an RFID tag with the unique package/item/shipment identifier stored therein.

In various embodiments, the package/item/shipment information/data comprises identifying information/data corresponding to the package/item/shipment. The identifying information/data may comprise information/data identifying the unique package/item/shipment identifier associated with the package/item/shipment. Accordingly, upon providing the identifying information/data to the package/item/shipment detail database (may be embedded in distribution computing entity), the package/item/shipment detail database may query the stored package/item/shipment profiles to retrieve the package/item/shipment profile corresponding to the provided unique identifier.

Moreover, the package/item/shipment information/data may comprise shipping information/data for the package/item/shipment. For example, the shipping information/data may identify an origin location (e.g., an origin serviceable point), a destination location (e.g., a destination serviceable point), a service level (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), whether a delivery confirmation signature is required, and/or the like. In certain embodiments, at least a portion of the shipping information/data may be utilized as identifying information/data to identify a package/item/shipment. For example, a destination location may be utilized to query the package/item/shipment detail database to retrieve data about the package/item/shipment.

In certain embodiments, the package/item/shipment information/data comprises characteristic information/data identifying package/item/shipment characteristics. For example, the characteristic information/data may identify dimensions of the package/item/shipment (e.g., length, width, height), a weight of the package/item/shipment, contents of the package/item/shipment, and/or the like. In certain embodiments, the contents of the package/item/shipment may comprise a precise listing of the contents of the package/item/shipment (e.g., three widgets) and/or the contents may identify whether the package/item/shipment contains any hazardous materials (e.g., the contents may indicate whether the package/item/shipment contains one or more of the following: no hazardous materials, toxic materials, flammable materials, pressurized materials, controlled substances, firearms, and/or the like).

### 4. Exemplary Mobile Computing Entity

Mobile computing entities 120 may be configured for autonomous operation and/or for operation by a user (e.g., a vehicle operator, delivery personnel, customer, and/or the like). In certain embodiments, mobile computing entities 120 may be embodied as handheld computing entities, such as mobile phones, tablets, personal digital assistants, and/or the like, that may be operated at least in part based on user input received from a user via an input mechanism. Moreover, mobile computing entities 120 may be embodied as onboard vehicle computing entities, such as central vehicle electronic control units (ECUs), onboard multimedia system, and/or the like that may be operated at least in part based on user input. Such onboard vehicle computing entities may be configured for autonomous and/or nearly autonomous operation however, as they may be embodied as onboard control systems for autonomous or semi-autonomous vehicles, such as unmanned aerial vehicles (UAVs), robots, and/or the like. As a specific example, mobile computing entities 120 may be utilized as onboard controllers for UAVs configured for picking-up and/or delivering packages to various locations, and accordingly such mobile computing entities 120 may be configured to monitor various inputs (e.g., from various sensors) and generated various outputs (e.g., control instructions received by various vehicle drive mechanisms). It should be understood that various embodiments of the present disclosure may comprise a plurality of mobile computing entities 120 embodied in one or more forms (e.g., handheld mobile computing entities 120, vehicle-mounted mobile computing entities 120, and/or autonomous mobile computing entities 120).

As will be recognized, a user may be an individual, a family, a company, an organization, an entity, a department within an organization, a representative of an organization and/or person, and/or the like—whether or not associated with a carrier. In one embodiment, a user may operate a mobile computing entity 120 that may include one or more components that are functionally similar to those of the clustering entities 100. FIG. 3 provides an illustrative schematic representative of a mobile computing entity 120 that can be used in conjunction with embodiments of the present disclosure. In general, the terms device, system, computing entity, entity, and/or similar words used herein interchangeably may refer to, for example, one or more computers, computing entities, desktops, mobile phones, tablets, phablets, notebooks, laptops, distributed systems, vehicle multimedia systems, autonomous vehicle onboard control systems, watches, glasses, key fobs, radio frequency identification (RFID) tags, ear pieces, scanners, imaging devices/cameras (e.g., part of a multi-view image capture system), wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Mobile computing entities 120 can be operated by various parties, including carrier personnel (sorters, loaders, delivery drivers, network administrators, and/or the like). As shown in FIG. 3, the mobile computing entity 120 can include an antenna 312, a transmitter 304 (e.g., radio), a receiver 306 (e.g., radio), and a processing element 305 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the mobile computing entity 120 may be capable of operating with one or more air interface standards, communication protocols, modulation types, and access types. More particularly, the mobile computing entity 120 may operate in accordance with any of a number of wireless communication standards and protocols, such as those described above with regard to the clustering entities 100. In a particular embodiment, the mobile computing entity 120 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the mobile computing entity 120 may operate in accordance with multiple wired communication standards and protocols, such as those described above with regard to the clustering entities 100 via a network interface 320.

Via these communication standards and protocols, the mobile computing entity 120 can communicate with various other entities using concepts such as Unstructured Supplementary Service information/data (USSD), Short Message Service (SMS), Multimedia Messaging Service (MMS), Dual-Tone Multi-Frequency Signaling (DTMF), and/or Subscriber Identity Module Dialer (SIM dialer). The mobile computing entity 120 can also download changes, add-ons, and updates, for instance, to its firmware, software (e.g., including executable instructions, applications, program modules), and operating system.

According to one embodiment, the mobile computing entity 120 may include location determining aspects, devices, modules, functionalities, and/or similar words used herein interchangeably. For example, the mobile computing entity 120 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire information/data, sometimes known as ephemeris information/data, by identifying the number of satellites in view and the relative positions of those satellites (e.g., using global positioning systems (GPS)). The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. This information/data can be collected using a variety of coordinate systems, such as the Decimal Degrees (DD); Degrees, Minutes, Seconds (DMS); Universal Transverse Mercator (UTM); Universal Polar Stereographic (UPS) coordinate systems; and/or the like. Alternatively, the location information can be determined by triangulating the mobile computing entity's 120 position in connection with a variety of other systems, including cellular towers, Wi-Fi access points, and/or the like. Similarly, the mobile computing entity 120 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices/entities (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The mobile computing entity 120 may also comprise a user interface (that can include a display 316 coupled to a processing element 305) and/or a user input interface (coupled to a processing element 305). For example, the user interface may be a user application, browser, user interface, and/or similar words used herein interchangeably executing on and/or accessible via the mobile computing entity 120 to interact with and/or cause display of information from the clustering entities 100, as described herein. The user input interface can comprise any of a number of devices or interfaces allowing the mobile computing entity 120 to receive information/data, such as a keypad 318 (hard or soft), a touch display, voice/speech or motion interfaces, or other input device. In some embodiments including a keypad 318, the keypad 318 can include (or cause display of) the conventional numeric (0-9) and related keys (#, *), and other keys used for operating the mobile computing entity 120 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

As shown in FIG. 3, the mobile computing entity 120 may also include an camera, imaging device, and/or similar words used herein interchangeably 326 (e.g., still-image camera, video camera, IoT enabled camera, IoT module with a low resolution camera, a wireless enabled MCU, and/or the like) configured to capture images. The mobile computing entity 120 may be configured to capture images via the onboard camera 326, and to store those imaging devices/cameras locally, such as in the volatile memory 315 and/or non-volatile memory 324. As discussed herein, the mobile computing entity 120 may be further configured to match the captured image data with relevant location and/or time information captured via the location determining aspects to provide contextual information/data, such as a time-stamp, date-stamp, location-stamp, and/or the like to the image data reflective of the time, date, and/or location at which the image data was captured via the camera 326. The contextual data may be stored as a portion of the image (such that a visual representation of the image data includes the contextual data) and/or may be stored as metadata associated with the image data that may be accessible to various computing entities.

The mobile computing entity 120 may include other input mechanisms, such as scanners (e.g., barcode scanners), microphones, accelerometers, RFID readers, and/or the like configured to capture and store various information types for the mobile computing entity 120. For example, a scanner may be used to capture package/item/shipment information/data from an item indicator disposed on a surface of a shipment or other item. In certain embodiments, the mobile computing entity 120 may be configured to associate any captured input information/data, for example, via the onboard processing element 308. For example, scan data captured via a scanner may be associated with image data captured via the camera 326 such that the scan data is provided as contextual data associated with the image data.

The mobile computing entity 120 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, information/data, applications, programs, program modules, scripts, source code, object code, byte code, compiled code, interpreted code, machine code, executable instructions, and/or the like to implement the functions of the mobile computing entity 120. As indicated, this may include a user application that is resident on the entity or accessible through a browser or other user interface for communicating with the clustering entities 100 and/or various other computing entities.

In another embodiment, the mobile computing entity 120 may include one or more components or functionality that are the same or similar to those of the clustering entities 100, as described in greater detail above. As will be recognized, these architectures and descriptions are provided for exemplary purposes only and are not limiting to the various embodiments.

### 5. Exemplary Package/Item/Shipment Information

As noted herein, various shipments/items may have an associated package/item/shipment profile (also referred to herein as a “parcel profile”), record, and/or similar words used herein interchangeably stored in a package/item/shipment detail database (or parcel detail database). The parcel profile may be utilized by the carrier to track the current location of the parcel and to store and retrieve information/data about the parcel. For example, the parcel profile may comprise electronic data corresponding to the associated parcel, and may identify various shipping instructions for the parcel, various characteristics of the parcel, and/or the like. The electronic data may be in a format readable by various computing entities, such as an clustering entity 100, a mobile computing entity 120, an autonomous vehicle control system, and/or the like. However, it should be understood that a computing entity configured for selectively retrieving electronic data within various parcel profiles may comprise a format conversion aspect configured to reformat requested data to be readable by a requesting computing entity. In various embodiments, the parcel profile is accessed (e.g., block 401 of FIG. 4) in order to generate output comprising clusters, as described in more detail herein.

In various embodiments, the parcel profile comprises identifying information/data corresponding to the parcel. The identifying information/data may comprise information/data identifying the unique parcel identifier associated with the parcel. Accordingly, upon providing the identifying information/data to the parcel detail database, the parcel detail database may query the stored parcel profiles to retrieve the parcel profile corresponding to the provided unique identifier.

Moreover, the parcel profiles may comprise shipping information/data for the parcel. For example, the shipping information/data may identify an origin location (e.g., an origin serviceable point), a destination location (e.g., a destination serviceable point), a service level (e.g., Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), whether a delivery confirmation signature is required, and/or the like. In certain embodiments, at least a portion of the shipping information/data may be utilized as identifying information/data to identify a parcel. For example, a destination location may be utilized to query the parcel detail database to retrieve data about the parcel.

In certain embodiments, the parcel profile comprises characteristic information/data identifying parcel characteristics. For example, the characteristic information/data may identify dimensions of the parcel (e.g., length, width, height), a weight of the parcel, contents of the parcel and/or the like. In certain embodiments, the contents of the parcel may comprise a precise listing of the contents of the parcel (e.g., three widgets) and/or the contents may identify whether the parcel contains any hazardous materials (e.g., the contents may indicate whether the package/item/shipment contains one or more of the following: no hazardous materials, toxic materials, flammable materials, pressurized materials, controlled substances, firearms, and/or the like).

### V. Exemplary System Operation

FIGS. 4-6 illustrates flow diagrams of example processes in accordance with some embodiments discussed herein. It will be understood that each block of the flowcharts, and combinations of blocks in the flowcharts, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory of an apparatus employing an embodiment of the present invention and executed by a processor of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture, the execution of which implements the functions specified in the flowchart blocks. The computer program instructions may also be loaded onto a computer or other programmable apparatus to cause a series of operations to be performed on the computer or other programmable apparatus to produce a computer-implemented process such that the instructions executed on the computer or other programmable apparatus provide operations for implementing the functions specified in the flowchart blocks.

FIG. 4 is a flow diagram of an example process 400 for generating output comprising clusters, according to particular embodiments. In some embodiments, the clustering entity 100 performs the process 400. In this regard, the clustering entity 100 may perform these operations through the use of one or more of processing element 305, non-volatile memory 310, and volatile memory 315. It will be understood that the clustering engine comprises a set of hardware components or hardware components coupled with software components configured to autonomously generate a cluster in particular embodiments. These components may, for instance, utilize the processing element 305 to execute operations, and may utilize non-volatile memory 310 to store computer code executed by the processing element 305, as well as to store relevant intermediate or ultimate results produced from execution of the clustering engine. It should also be appreciated that, in some embodiments, the clustering engine may include a separate processor, specially configured field programmable gate array (FPGA), or application specific interface circuit (ASIC) to perform its corresponding functions. In addition, computer program instructions and/or other type of code may be loaded onto a computer, processor or other programmable apparatus's circuitry to produce a machine, such that the computer, processor other programmable circuitry that execute the code on the machine create the means for implementing the various functions described in connection with the clustering engine.

At block 401, one or more clustering information units are accessed (e.g., by a clustering engine) from a clustering data management tool, wherein the one or more clustering information units comprise clustering data. In some embodiments, the clustering data comprises one or more of: package received time and package information. In some embodiments, the clustering data comprises one or more of: package received time, manifest package time, package information such as tracking number, package activity time stamp, package dimension including the height, length and width of the package, package weight, package manifested weight, package manifest time stamp, package service type, package scanned time stamp, package tracking number, package sort type code, package scanned code, unit load device type code, account number associated with the package, and the like. In some embodiments, clustering data may be received from vehicles (e.g., the vehicle 107) and/or mobile computing entities (e.g., mobile computing entity 120). In some embodiments, clustering data can be pre-processed by another learning model, such as a shipper behavior learning model. In an example illustration, the clustering entity 100 may receive, over a computer network 105, clustering information from the mobile computing entity 120 and/or the vehicle 107.

In some embodiments, accessing the volume information units at block 401 is associated with one or more rules in order for the process 400 to automate. For example, a first rule may be, if one or more users (e.g., the first 50 users) or other entity provides one or more package manifests (e.g., a batch of 100 package manifests), provides shipping transaction data (e.g., data from one or more labels printed for a user at a shipping store), and/or any cluster data, the system automatically accesses volume information units at block 401, automatically extracts features at block 402, and automatically generates output at block 403 for the data provided by the user or other entity. In this way, particular embodiments improve existing technology by automating functionality that was previously performed via manual computing system entry, such a user generating its own prediction value or entering a value under a category/domain into a computer system based on personal observation or manually inputting spreadsheet values for prediction. In an example illustration of particular embodiments, a rule may be that the process 400 will automatically occur only after X time period (e.g., 20 days) for all data received (e.g., 100 package manifests). In this way automation can be batched or chunked to reduce I/O cycles.

At block 402, the clustering engine extracts one or more features from the one or more clustering information units, wherein the one or more features are representative of one or more of a shipping unit behavior data and package information. In some embodiments, the features are generated by directly copying clustering information units. Alternatively or in addition, the features can be generated from other techniques, such as categorizing or classifying information. For example, if a clustering information unit comprises “manifest time: 9:00 am; received time: 10:04 am; package weight: 30 lb”, the features generated can be based on separating each of the constituent elements present in the clustering information unit, and in this case, the first feature may be “manifest time: morning”, the second feature may be “received time: morning”, and the third feature may be “package weight: heavy”. In some embodiments, one feature may be generated based on multiple clustering information units. For example, package received time for multiple occasions can be used to generate one feature. A clustering engine may use clustering information units that represent package received in the past two months at building coded 5cdx and generate a feature called “total amount of packages during the past two months at building coded 5cdx”. Features can be generated for each hierarchical level. For example, for one or more of an account type, service type, building type, sort type, building identifier, package weight category, package dimension category, other categorizations of packages, shipper, or facilities in the shipping process, and the like. Further, the features can be pre-processed (labeled, categorized, etc.,) behavioral data. In some embodiments, the features represent results from a shipping unit learning model such as a shipper behavior learning model. For example, the features may comprise data that indicates categorization of shipper based on whether the shipper is timely or not, the average volume provided by this shipper, etc. Similarly, the features may comprise data that represents characteristics of other shipping units such as volume, timeliness, accuracy, and package information. The characteristics may take the form of labels, time period specific labels, categorizations, predictions, and the like.

At block 403, the clustering engine generates an output comprising cluster of a shipping unit using a shipping unit clustering learning model and the one or more features. The output can take the form of different pre-defined clusters based on the need of the user of the model.

In some embodiments, the clustering model operates by grouping a set of features and shipping units in a way such that the shipping units in the same “cluster” are more similar (e.g., they have analogous semantic context) with each other in their characteristics than they are with the shipping units falling into other clusters. For example, if one is clustering shippers, the output clusters may comprise different defined categorization of shippers. In another example, if one is using the model to cluster other shipping units such as buildings, package handlers, and package delivery drivers, the output clusters may comprise defined categorization of: buildings, package handlers and package delivery drivers. Example clusters of shippers include one or more of: early shippers, accurate shippers, late shippers, morning shippers, afternoon shippers, night shippers, shippers with large packages, shippers with small packages, shippers with overweight packages, frequent shippers, business shippers, shippers with large volume, shippers with small volume, industry categorizations of different business shippers, shippers characterized by other package information, associations of any of the previously mentioned categories, and the like. Other shipping units, such as buildings, package handlers, package delivery drivers, etc., can be categorized using similar categories. In some embodiments, the clusters in the model are first defined by respective features fed into the model. For example, clusters can be based on “shipper accuracy”. Then after the clusters are generated, the generated clusters will be manually labelled as “early shippers”, “accurate shipper”, and “late shippers” for as fit. The shipping unit clustering learning model can utilize one or more clustering models, for example, k-means clustering model, hierarchical clustering model, x means clustering model, distribution based clustering model or density based clustering model, and the like to generate these clusters of shipping units.

In some embodiments, the learning models can be implemented using programming languages such as R, Java, Python, Python, Scala, C, Weka or C++, although other languages may be used in addition or in the alternative. Similarly, the learning models can be implemented using existing software modules and framework such as Apache Spark, Apache Hadoop, Apache Storm, or Apache Flink, although other frameworks may be used in addition or in the alternative. Additionally or alternatively, the shipper behavior learning model is capable of running on a cloud architecture, for example, on cloud architectures based on existing frameworks such as a Hadoop Distributed File System (HDFS) of a Hadoop cluster. In some embodiments, the cloud architectures are memory based architectures where RAM can be used as long term storage to store data for faster performance and better scalability compared to other types of long term storage, such as a hard disk.

In some embodiments, the k-means clustering model used in the shipping unit clustering learning model operates by partitioning the features extracted into k clusters. The number of k is calculated via various techniques like finding the number of k is via the elbow method, which operates by looking at the percentage of variance as a function of the number of clusters, then choose a number of clusters where adding another cluster does not produce a better model of the underlying data. The basis for judging the quality of the model can be manual observation in some embodiments. Additionally, silhouette method can be used to check if the suggested object lay within a cluster by measuring the grouping of the objects in the cluster, where lower the number is better for clustering. Once the k value is determined using elbow method a simple cross-validation method can be used to verify is the suggested k value is correct.

After defining k clusters, the model will assign each feature extracted to the cluster which has the closest mean. The initial set of means can be generated randomly or based on other algorithms. In some embodiments, a centroid like model can be used to get clusters. A trinary chart (or other chart, such as illustrated in FIGS. 9A and 9B) can be created to visualize the clusters to cross check the clustering assignments. A trinary chart graphically represents ratios or percentages of three variables in an equilateral triangle that sum to a constant. The three variables represent 3 different clusters, where each data point is plotted within the trinary chart to indicate the proportion of cluster(s) it belongs to. For example, for a shipper behavior data point (e.g., a shipment was shipped on Saturday), it may be 90% likely that the data point is grouped to a “weekend” cluster and 10% likely the data point belongs to a “beginning-of-week” or “mid-week” cluster. When using features having a quantitative value such as features representing weight, accuracy in percentages, volume in numbers and the like, the closest cluster is often the cluster where the difference between the quantitative values defining the cluster is the smallest. For features comprising qualitative data, such as service types, building types, shipper categorizations and other categorizations based on package information, one can assign a quantitative value to the qualitative value. For example, one can assign “late shippers” as negative 1 and “early shippers” as positive 1. The assignments can be adjusted based on the user's needs. When using features having a qualitative value (e.g., Monday, Tuesday, Wednesday, etc.), the closest cluster is often the cluster where the cardinality (quantity of elements in a set) difference between set elements is the smallest. For example, Monday is closest to Tuesday in an ordered seven day week. Accordingly, Monday and Tuesday are more likely to be clustered together than Monday and Saturday.

After the features are assigned into clusters, the k-means based clustering model will calculate the new means for the different clusters by calculating the means of the various features in the clusters. After the new means are calculated, the assignments of shipping units to clusters will be updated. The process of updating assignments and calculating means may keep repeating itself for a pre-determined number of rounds or until an update process does not change any of the assignments. In some embodiments, after the process stops, the k-means based clustering model may output the clusters and features as the output of the shipping unit clustering learning model.

In some embodiments, the features outputted by the k-means based clustering model, along with the respective clusters, may serve as the input for another learning model, such as any supervised or unsupervised learning model. In an example illustration of clustering at block 403, any of the shipping unit behavior data as described herein can be clustered in response to predictions described herein. For example, shippers can be clustered into “accurate” or “not accurate;” package handler facilities can be clustered into groups of “accurate” or “not accurate;” delivery drivers can be clustered into groups of “accurate driver” or “not accurate driver;” shipments can be clustered into industry segments, such as “industry segment A” and “industry segment B;” seasons (and/or months, weeks, etc.) can be categorized into “busy,” “not busy,” or “moderately busy;” weather for a given time period (e.g., day, week, month, season, etc.) may be categorized as “good weather” or “bad weather,” or more specific, such as “sunny,” “snowy,” “rainy,” etc. In yet another example shipping facilities or instances of facilities (e.g., particular conveyor belt facilities) may be clustered into groups of “bottleneck” or “smooth” categories.

FIG. 5 is a flow diagram of an example process 500 for updating a cluster engine, according to some embodiments. In some embodiments, the clustering engine is embedded in clustering entity 100. In some embodiments, the process 500 is performed by the clustering entity 100. In this regard, the clustering entity 100 may perform these operations through the use of one or more of processing element 305, non-volatile memory 310, and volatile memory 315. In some embodiments, the process 500 occurs in response to or subsequent to the process 400 of FIG. 4.

At block 501, additional clustering data is received (e.g., by a clustering engine) after a particular time period (e.g., time subsequent to the process 400). In some embodiments, the particular time period reflects the time period when additional cluster information pre-defined as appropriate are received in FIG. 4. For example, if the cluster information comprises features previously used to generate volume forecasts for the first five days (e.g., days 1-5) for building coded 3xyz; the particular time period may be configured as time period where additional clustering data is received for the next five days (e.g., days 6-10) for building coded 3xyz. If the cluster information comprises features previously used to predict behavior, then the particular time period may reflect a time period where more behavior more information are expected. At block 502, the clustering engine extracts one or more features from the additional clustering data. At block 503, the clustering engine updates the clustering engine based on the features extracted from additional clustering data. In some embodiments, the clustering engine updates itself by changing the decision tree parameters associated with the shipping unit clustering learning model. In some embodiments, clusters are changed or modified at block 503 and/or additional clusters are generated compared to the clusters generate at block 403. For example, a first cluster can be made via the process 400 indicating that a shipper has been clustered as an “accurate” shipper. In response to blocks 501 and 502 to process additional data, the distance between one or more data points in the first cluster and the mean of the first cluster can change, based on processing the additional data. In various embodiments, this change may cause one or more data points (e.g., a shipper identifier) to change from the first cluster to another cluster, as described in more detail herein. In this way, as the system processes more data, the clusters or mean of the clusters becomes more precise, such that cluster prediction becomes more accurate.

FIG. 6 is a flow diagram of an example process for modifying a shipping unit clustering model, according to some embodiments. In some embodiments, the process 600 is performed by the clustering engine embedded in the clustering entity 100. In this regard, the apparatus 100 may perform these operations through the use of one or more of processing element 305, non-volatile memory 310, and volatile memory 315.

At block 601, the clustering engine receives additional clustering data after a particular time period (e.g., after the process 400). At block 602, the clustering engine extracts one or more features from the additional clustering data (e.g., the additional clustering data at block 501 or current data). At block 603, the clustering engine accesses historical data to generate a historical data set for one or more historical clusters. In some embodiments, “historical data” may be or include any data that was received and/or analyzed prior to the receiving of the cluster data at block 601. At block 604, the clustering engine extracts one or more features from the historical data set. As illustrated on the FIG., block 601 to 602 can happen before, after or concurrently with block 603 to 604. At block 605, the clustering engine compares the features extracted from the additional clustering data with the features extracted from the historical data set. At block 606, the clustering engine modifies the shipping unit clustering learning model stored in the clustering engine based on the difference between the one or more features extracted from the additional clustering data and the one or more features extracted from the historical data set. In some embodiments, the clustering engine modifies the shipping unit clustering learning model by reading inputs from an operator or a learning model analyzing the difference between the one or more features extracted from the additional clustering data and the one or more features extracted from the historical data set.

In an example illustration of the comparing and modifying of the learning model according to blocks 605 and 606, at a first time a first mean of a first cluster may be a first value (before the modifying at block 606) based only on running the historical data of block 603 through a learning model. In various embodiments, the “features” correspond to data points within a cluster. Accordingly, in a K=3 learning model, for example, 3 distinct data points are selected as the original clusters. Then, when additional clustering data is received and features extracted (per blocks 601 and 602), the first cluster can be refined or changed (e.g., there are more data point values added, which changes the mean). For example, after the 3 distinct data points are selected, a distance (e.g., Euclidian distance) is measured between a first point (of a plurality of data points in the first cluster) and each of the 3 data points. Then the first point is assigned to the nearest of the 3 points. This step is repeated for each point. After each point is assigned to one of the 3 points or clusters, a second mean or center point of the first cluster is then generated, which usually changes or modifies to a second value based on receiving additional data. The first mean value is compared to the second mean value. If the change between the first mean value and the second mean value is over a threshold, then another 3 random selection of data points can occur and the process is repeated. Each iteration of clustering thus “modifies” the shipping unit clustering learning model in various embodiments. In this way, the clustering can be further refined in order to make future predictions more accurate as described in more detail below.

FIG. 7 is a block diagram of example components of an example shipping unit clustering learning model training environment 700 that is used to train the shipping unit clustering learning model that is relied upon by the clustering entity 100 to update shipping unit clustering learning model in some example embodiments. The depicted shipping unit clustering learning model training environment 700 comprises a training engine 702, shipping unit clustering learning model 710, and a clustering data management tool 715. “Training” as described herein in some embodiments includes a user manually mapping each training data point to a target attribute or correct cluster and the model locates or identifies patterns within the target attribute in preparation for testing (e.g., running a data set through a model without a user mapping to a target attribute; rather the system automatically maps without user interaction). For example, training data may include 10 weight values, which may each be over 3 pounds. A user may input information on a computing device and associate each of the weight values to a “heavy” cluster. The system may identify the actual values as being associated with a “heavy” cluster. In this way at testing time, the system may automatically map any current values to the same or similar values that have already been mapped to the heavy cluster via a user device.

In some examples, the clustering data management tool 715 comprises a variety of clustering data. In some examples, the historical data, as described herein, may be obtained and/or stored after clustering entity 100 receives package received time data. For example, the clustering data management tool 715 may comprise a variety of clustering data such as historical building data 720, shipper behavior data 722, package handler behavior data 724, package information 726, and/or other data 728. In various embodiments, each of these data sets is combined in the clustering data management tool 715 to include the shipping unit behavior data as described herein. In some embodiments, the clustering data management tool 715 communicates over a computer network (e.g., the network 105) to various data sources to obtain the building data 720, shipper behavior data 722, the package handler behavior data 724, the package information 726, and/or the other data 728. In some embodiments, the building data 720 represents a data store that stores attributes of one or more shipping facilities (e.g., address, processing times of various legs, shipment volume received, etc.). In some embodiments, the shipper behavior data 722 represent s a data store that stores shipper behavior data as described herein (e.g., indications of whether a user has been accurate or not). In some embodiments, the package handler behavior data 724 is a data store that stores attributes associated with a package handler (e.g., driver accuracy history). In some embodiments, the package information 726 represents a data store that includes various attributes of one or more parcels (e.g., parcel weight, height, length, size, package manifest time, etc.).

In some embodiments, the clustering data comprises one or more of: package received time, manifest package time, package information such as tracking number, package activity time stamp, package dimension including the height, length and width of the package, package weight, package manifested weight, package manifest time stamp, package service type, package scanned time stamp, package tracking number, package sort type code, package scanned code, unit load device type code, account number associated with the package, and the like. In some embodiments, clustering data may be received from vehicles or mobile computing entities.

In some examples, the training engine 702 comprises a normalization module 706 and a feature extraction module 704. The normalization module 706, in some examples, may be configured to normalize (e.g., via Z-score methods) the historical data so as to enable different data sets to be compared. In some examples, the feature extraction module 704 is configured to parse the clustering data into clustering information units relevant to modeling of the data, and non-clustering information units that are not utilized by the shipping unit clustering learning model 710, and then to normalize each distinct clustering information units using different metrics. Normalization is the process of changing one or more values in a data set (e.g., the clustering data management tool 715) to a common scale while maintaining the general distribution and ratios in the data set. In this way, although values are changed, differences between actual values in the data set are not distorted such that information is not lost. For example, values from the clustering data management tool 715 may range from 0 to 100,000. The extreme difference in this scale may cause problems when combining these values into the same features for modeling. In an example illustration, this range can be changed to a scale of 0-1 or represent the values as percentile ranks, as opposed to absolute values.

The clustering information units can be labeled or clustered based on one or more of: package received time, package manifest time, package dimension, package weight, frequency of shipping from a particular shipper associated with the package, building type, account type, sort type, other package information from scanners, other package information from package manifest, other package information from mobile computing entities, and the like. Moreover, clustering information units can be labeled or clustered by geographical data, traffic data, holiday information, weather reports, political events, and the like. For the purpose of categorizing the clustering information units, the information used to label or categorize clustering information units may be pre-processed (such as labeled, categorized and parsed) by another model. Alternatively or additionally, the normalization module 706 may be usable with respect to processing clustering data in the clustering data management tool 715, such as to normalize the clustering data before the clustering data is labeled or otherwise characterized by feature extraction module 704. For example, repetitive clustering data corresponding to the same instance received from multiple sources may be deduplicated.

Finally, the shipping unit clustering learning model 710 may be trained to extract one or more features from the historical data using pattern recognition, based on unsupervised learning, supervised learning, semi-supervised learning, reinforcement learning, association rules learning, Bayesian learning, solving for probabilistic graphical models, k-means based clustering, other clustering models, exponential smoothing, random forest model based learning, or gradient boosting model based learning, among other computational intelligence algorithms that may use an interactive process to extract features from clustering data. In some embodiments, the shipping unit clustering learning model is a time series learning model.

In an example illustration of training according to the system 700, data may be obtained from the various data sources by the clustering data management tool 715 (various historical documents, such as package manifests and shipping transaction histories over a particular time frame). In order to provide more meaning to the data, the feature extraction module 704 can extract one or more features from the data in the volume forecast data management tool 715. For example, a user can create a data structure of various features, such as “morning,” “afternoon,” “evening,” “light parcel,” “heavy parcel,” “January,” (each of these are clusters) and associate specific data within the cluster data management tool 715 with the clusters. For example, training data indicating that a parcel was received at “3:00 p.m.” is associated with the “afternoon” feature. In like manner, training data indicates that a parcel was “4 LBS” was associated with the “heavy parcel” feature.

In some embodiments, after each feature is extracted via the feature extraction module 704, each set of data within each feature can then be normalized via the normalization module 706 in some embodiments. Each value (e.g., 87 shipments) of each feature represents data points in a learning model where patterns and associations are made to make a suitable projection for clustering. For example, after the data points of the features are all associated to one or more clusters by a user, the clustering learning model 710 can then identify patterns and associations in this clustered data to learn for future clustering of data. For example, the clustering learning model 710 may have identified a pattern that every shipper that provided the wrong zip code 4 times or more in a history of shipments were placed in a “not accurate” cluster, whereas every shipper that provided the wrong zip code 3 times or less were placed in an “accurate” cluster. Accordingly, based on this historical information, in response to receiving a current shipper request from a user, and identifying that the user has made 5 mistakes in the past with respect to zip codes, the system may cluster the user as “not accurate.” In this way, shipping facilities can more carefully process a shipment if a user was clustered in this group, since it is more likely that the shipper has made a mistake.

FIG. 8 is an example block diagram of example components of an example shipping unit clustering learning model service environment 800. In some example embodiments, the example shipping unit clustering learning model service environment 800 comprises clustering data 810, a clustering engine 830, output 840, the clustering data management tool 715 and/or the shipping unit clustering learning model 710. The clustering data management tool 715, a clustering engine 830, and output 840 may take the form of, for example, a code module, a component, circuitry and/or the like. The components of the shipping unit clustering learning model service environment 800 are configured to provide various logic (e.g. code, instructions, functions, routines and/or the like) and/or services related to the shipping unit clustering learning model service environment.

In some examples, the clustering data 810 comprises historical package received time data, shipper profile, package manifest, package information, and/or other data. In some examples, the clustering data management tool 715 may be configured to normalize the raw input data, such that the data can be analyzed by the clustering engine 830. In some examples the clustering data management tool 715 is configured to parse the input data interaction to generate one or more clustering information units. Alternatively or additionally, the clustering engine 830 may be configured to extract one or more features from the one or more clustering information units. In some embodiments, the features are generated by directly copying clustering information units. Alternatively or in addition, the features can be generated using other techniques. For example, if the clustering information unit comprises “manifest time: 9:00 am; received time: 10:04 am; package weight: 30 lb”, the features generated can be based on categorization of each of the elements present in the clustering information units in the form of “manifest time: morning; received time: morning; package weight: heavy”. In some embodiments, one feature may be generated based on multiple clustering information units. For example, package received time for multiple occasions can be used to generate one feature. A clustering engine may use clustering information units that represents package manifest time and package received time in the past two days in building coded 3xyz and generate a feature called “total volume for past two days”.

In some examples, clustering data management tool 715 and clustering engine 830 are configured to receive data from a shipping unit clustering learning model, wherein the shipping unit clustering learning model was derived using a historical clustering data set. Alternatively or additionally, the clustering engine 830 may be configured to generate generating an output 840 based on the shipping unit clustering learning model and the one or more features.

Efficiently allocating resources throughout the chain of delivery depends on information regarding shipping units in all of the steps involved. For example, information regarding the shipper, the building handling the packages, package handlers, delivery drivers, and the like are all needed to maximize the efficiency of an organization. However, the amount of information regarding all these steps could be overwhelming and one needs a way of managing and utilizing the various sets of information.

By providing clusters of shipping units using clustering entity 100 to a computing entity configured to determine resource allocations, resources can be better allocated with regard to each transportation facility. For example, if one identifies a number of shipping units that over-perform, one can adjust resources allocation accordingly. Moreover, by identifying underperforming (low accuracy, etc.,) package handlers and package delivery drivers, special training programs can be provided to these package handlers and package delivery drivers. By autonomously clustering the shipping units using clustering entity 100, a computing entity configured to determine resource allocations can reduce issues caused by human error and mitigate potential resource misallocation.

FIGS. 9A and 9B are schematic diagrams of a scatter plot at a first time and second time, for which aspects of the present disclosure can be implemented in, according to some embodiments. In some embodiments, the scatter plot 900 represents at least a portion of the output generated at block 403 of FIG. 4, the updating of the cluster engine at block 503 of FIG. 5, and/or the modifying of the shipping unit clustering learning model at block 606 of FIG. 6. Likewise, in some embodiments, the scatter plot 900 represents at least some functionality performed by the clustering learning model 710 of FIG. 7 and/or the shipping unit clustering learning model 710 of FIG. 8. Although the scatter plot 900 includes specific values, clusters (e.g., K=3), and models, it is understood that any particular values, clusters, and models may exist. Accordingly, although the description of these figures relate to the particular values, it is understood that the description can apply to any set of values, clusters, and/or models. In some embodiments, the scatter plot 900 is caused to be displayed (e.g., by the clustering entity 100 to the mobile computing entity 120) in response to generating or modifying an output of clusters (e.g., block 403 of FIG. 4).

FIG. 9A is a schematic diagram of a scatter plot 900 at a first time, according to particular embodiments. The scatter plot 900 of FIG. 9A includes a plurality of data points (e.g., data point 907, data point 921) that are clustered into three different groups represented by circles, squares, and triangles. The clusters and data points can represent any suitable value as described herein. For example, each data point can represent a day of week that various shippers have historically shipped parcels. In some embodiments, the scatter plot 900 represents the clustering of data after only 1 or a few (e.g., 2-8) iterations. Prior to the first time, a user can select the quantity of clusters he or she wants to identify in the data. This is the “k,” value for example in k-means clustering. For example, the user can group data into a “beginning-of-the week” cluster (e.g., Monday and Tuesday), a “mid-week” cluster (e.g., Wednesday and Thursday), and a “weekend” cluster (e.g., Friday, Saturday, and Sunday), where each cluster and data point is indicative of when a parcel of shipment is handed off to carrier personnel (k=3). In some embodiments, the k-value that is selected is determined by calculating the “elbow point” in a plot or a point at which variation between data points goes from a relatively large reduction in variation to minimal reduction in variation, as described herein.

Next, in various embodiments, the k value of distinct data points are randomly selected (e.g., by the clustering learning model 710) as the initial clusters. For example, where k=3, the data points 905, 901, and 903 can be selected as the initial clusters. Next, a distance can be measured (e.g., by the clustering learning model 710) between a first point of a plurality of data points and each point of the initially selected clusters. For example, within the scatter plot 900, the data point 907 is selected (e.g., as the “first point”), then the distance (e.g., Euclidian distance) between the data point 907 and each of the initially selected clusters 901, 905, and 903 is measured. Next, the first point is assigned (e.g., by the clustering learning model 710) to the nearest of the initially selected clusters, such that two points are now within the same cluster. For example, the data point 907 is assigned to the cluster or data point 901, since the distance between the data point 907 and 901 is closer than the distance between data point 907 and either of the two data points 903 and 905. Next, this process is repeated for each data point in the scatter plot 900. For example, data point 911 is selected. Then a distance is measured between data point 911 and each of the three initially selected cluster data points 905, 901, and 903. Because data point 911 is closer, in distance, to the initial cluster data point 903 than any of the other initially selected clusters 901 and 905, the data point 911 is assigned to the cluster 903 to belong to the same cluster or group.

In some embodiments, after each point of the plurality of points has been assigned to a cluster the mean or center data point of each cluster is then calculated (e.g., by the clustering learning model 710), which concludes a first round of clustering. Responsively, each center data point is then used as initial data point clusters and the process described above is repeated for a second round of clustering. For example, the mean of a first cluster may be the data point 921, the mean of a second cluster may be the data point 925, and the mean of a third cluster may be data point 923. Accordingly, a distance is measured between a first point (e.g., data point 907) and each of the initially selected data point clusters 921, 925, and 923. The first point is then assigned to the nearest of the three clusters. For example, data point 907 can be assigned to the data point 923 since it is the closest. This process is repeated for each of the points in the scatter plot 900 of FIG. 9A. In some embodiments, after this second round (or other quantity) of assigning data points to clusters and determining another mean value, it is determined (e.g., by the clustering learning model 710) whether there have been clustering changes above a threshold. For example, it is determined whether the change in clusters between the first round and second round have changed outside of some threshold (e.g., the mean is plus or minus a particular value in difference between the first round and the second round). If there has been no change outside of a threshold, then the clustering process can conclude. However, if there is a change outside of the threshold, then particular rounds can be added until the clusters do not change outside of the threshold.

FIG. 9B is a schematic diagram of the scatter plot 900 at a second time subsequent to the first time illustrated in FIG. 9A. FIG. 9B represents the changing of the clusters after one or more rounds or iterations according to the functionality described above with respect to FIG. 9A. As illustrated if FIG. 9B, the triangle cluster includes more data points or is larger compared to its cluster as represented in FIG. 9A. As also illustrated in FIG. 9B, each of the clusters are also in different orientations and cover different distances compared to their corresponding cluster in FIG. 9A. In this way, the clusters in FIG. 9B represent a more accurate depiction of clusters and therefore a likelihood that an incoming data point will be assigned to the correct cluster.

In some embodiments, the scatter plot 900 (or any learning model described herein) of FIG. 9B represents 3 plotted clusters that categorize shippers, where each individual data point represents a unit of past behavior of shippers. In this way, it can be predicted what cluster a shipper or set of shippers belongs to for future shipments. Each of the data points represents a corresponding shipment or set of shipments of a particular shipper for the particular behavioral attribute(s) being clustered. For example, data point 907 may represent a first parcel that is to be shipped to a destination by a first shipper on Tuesday (e.g., the behavioral attribute). The data point 901 may represent a second parcel that is to be shipped to a destination by a second shipper on Wednesday, etc. Continuing with this example, the first triangle-shaped clusters represent weekend shipments (e.g., Friday through Sunday), the second box-shaped clusters represent mid-week shipments (e.g., Wednesday through Thursday), and the third circle-shaped clusters represent beginning-of-the-week shipments (e.g., Monday and Tuesday). Accordingly, the distance between each data point may dependent on how similar each behavior attribute value is. For example, Monday and Tuesday are close in in a seven day sequence. Accordingly, they are grouped together. In some embodiments, the scatter plot 900 if FIG. 9B represents a trained learning model (e.g., by the training engine 702), such that any current or future values can be fed into a clustering learning model and can be clustered according to the scatter plot 900 of FIG. 9B. Continuing with the example above, the data point 950 may represent a presently received shipment, where the package manifest reveals that a package is to be shipped on Wednesday for a first shipper. In this way, the shipper and this particular shipment is categorized as a “mid-week shipment.” This analysis can be used for other predictions, such as how many parcels will be received according to the cluster, such as how many packages will be received at the beginning of the week, mid-week, and the weekend.

In some embodiments, the methods, apparatus, and computer program products described herein comprise or utilize a clustering engine configured to: access one or more clustering information units from a clustering data management tool, wherein the one or more clustering information units comprise clustering data, wherein the clustering data comprises one or more of: shipping unit behavior data and package information; extract one or more features from the one or more clustering information units, wherein the one or more features are representative of one or more of: shipping unit behavior data and package information; and generate, using a shipping unit clustering learning model and the one or more features, an output comprising cluster of a shipping unit.

Optionally, in some embodiments of the present disclosure, the shipping unit comprises one or more of: shippers, buildings, package handler or package delivery drivers.

Optionally, in some embodiments of the present disclosure, the cluster of a shipping unit is based on one or more of: shipper behavior, building volume, package handler or package delivery driver behavior.

Optionally, in some embodiments of the present disclosure, the clustering information units comprises one or more of: industry segment categorization of business shippers, industry segment categorization of packages, weather information associated with packages, or events information associate with packages.

Optionally, in some embodiments of the present disclosure, the output comprises cluster of one or more of: shippers, buildings, package handler or package delivery drivers.

Optionally, in some embodiments of the present disclosure, the shipping unit clustering learning model is a k-means based clustering model.

Optionally, in some embodiments of the present disclosure, the k-means based clustering learning model has k different clusters of output.

Optionally, in some embodiments of the present disclosure, the value of k is determined by using elbow method.

Optionally, in some embodiments of the present disclosure, the shipping unit clustering learning model comprises one of: k-means clustering model, hierarchical clustering model, x means clustering model, distribution based clustering model or density based clustering model.

Optionally, in some embodiments of the present disclosure, the clustering engine is further configured to: receiving additional clustering data after a particular future time period; extracting one or more features from the additional clustering data; and updating the clustering engine based on the features extracted from additional clustering data.

Optionally, in some embodiments of the present disclosure, the system or method, further comprises a training engine configured to: receive additional clustering data after a particular future time period; extract one or more features from the additional clustering data; access historical data to generate a historical data set for one or more historical clusters; extract one or more features from the historical data set; comparing the one or more features extracted from the additional clustering data with the one or more features extracted from the historical data set; modify the shipping unit clustering learning model stored in the clustering engine based on the comparison of the one or more features extracted from the additional clustering data and said one or more features extracted from the historical data set.

Optionally, in some embodiments of the present disclosure, the clustering data comprises one or more tracking number, package activity time stamp, package manifest time, service type, package dimension, package height, package width, package length, or account number associated with a shipper.

Optionally, in some embodiments of the present disclosure, the features extracted from the one or more clustering information units comprise one or more of a residential indicator, a hazardous material indicator, an oversize indicator, a document indicator, a Saturday delivery indicator, a return service indicator, an origin location codes, a set of destination location codes, a package activity time stamp, a set of scanned package dimensions, and a set of manifest package dimensions.

### VI. Conclusion

Many modifications and other embodiments of the inventions set forth herein will come to mind to one skilled in the art to which these inventions pertain having the benefit of the teachings presented in the foregoing description and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus for autonomously clustering shipping units, the apparatus comprising a clustering engine configured to:
access clustering information units from a clustering data management tool, wherein the clustering information units comprise clustering data, wherein the clustering data comprises one or more of: shipping unit behavior data and package information;
extract one or more features from the clustering information units, wherein the features are representative of the one or more of the shipping unit behavior data or the package information; and
generate, using a shipping unit clustering learning model and the one or more features, an output comprising cluster of shipping units.

2. The apparatus of claim 1, wherein the shipping unit comprises one or more of: a shipper, a building, a package handler or a package delivery driver.

3. The apparatus of claim 2, wherein the cluster of a shipping unit is based on one or more of: shipper behavior, building volume, package handler behavior or package delivery driver behavior.

4. The apparatus of claim 2, wherein the clustering information units comprises one or more of: an industry segment categorization of business shippers, an industry segment categorization of packages, weather information associated with packages, or event information associate with packages.

5. The apparatus of claim 1, wherein the output comprises a cluster of a plurality of entities including one or more of: shippers, buildings, package handler or package delivery drivers.

6. The apparatus of claim 1, wherein the shipping unit clustering learning model is a k-means based clustering model.

7. The apparatus of claim 6, wherein the k-means based clustering learning model has k different clusters of output.

8. The apparatus of claim 7, wherein the value of k is determined using an elbow method.

9. The apparatus of claim 1, wherein the shipping unit clustering learning model comprises one of: a k-means clustering model, a hierarchical clustering model, an x means clustering model, a distribution based clustering model or a density based clustering model.

10. The apparatus of claim 1, wherein the clustering engine is further configured to:
receive additional clustering data after a particular future time period;
extract one or more features from the additional clustering data; and
update the clustering engine based on the features extracted from additional clustering data.

11. The apparatus of claim 1, further comprising a training engine configured to:
receive additional clustering data after a particular future time period;
extract one or more features from the additional clustering data;
access historical data to generate a historical data set for one or more historical clustering;
extract one or more features from the historical data set;
compare the one or more features extracted from the additional clustering data with the one or more features extracted from the historical data set;

12. The apparatus of claim 1, wherein the clustering data comprises one or more tracking number, package activity time stamp, package manifest time, service type, package dimension, package height, package width, package length, or account number associated with a shipper.

13. The apparatus of claim 1, wherein the features extracted from the one or more clustering information units comprise one or more of a residential indicator, a hazardous material indicator, an oversize indicator, a document indicator, a Saturday delivery indicator, a return service indicator, an origin location codes, a set of destination location codes, a package activity time stamp, a set of scanned package dimensions, and a set of manifest package dimensions.

14. A method for autonomously clustering shipping units, the method comprising:
accessing, using a clustering engine, one or more clustering information units from a clustering data management tool, wherein the one or more clustering information units comprise clustering data, wherein the clustering data comprises one or more of shipping unit behavior data or package information;
extracting, using the clustering engine, one or more features from the clustering information units, wherein the features are representative of one or more of shipping unit behavior data and package information; and
generating, using a shipping unit clustering learning model and the one or more features, an output comprising cluster of shipping units.

15. The method of claim 14, wherein the shipping unit comprises one or more of: shippers, buildings, package handler or package delivery drivers.

16. The method of claim 15, wherein the cluster of a shipping unit is based on one or more of: shipper behavior, building volume, package handler behavior or package delivery driver behavior.

17. The method of claim 15, wherein the clustering information units comprises one or more of: industry segment categorization of business shippers, industry segment categorization of packages, weather information associated with packages, or events information associate with packages.

18. The method of claim 14, wherein the output comprises cluster of one or more of: shippers, buildings, package handler or package delivery drivers.

19. The method of claim 14, wherein the shipping unit clustering learning model is a k-means based clustering model.

20. A non-transitory computer readable storage medium storing computer-readable program instructions that, when executed, cause a computer to:
access one or more clustering information units from a clustering data management tool, wherein the one or more clustering information units comprise clustering data, wherein the clustering data comprises one or more of: shipping unit behavior data and package information;
extract one or more features from the one or more clustering information units, wherein the one or more features are representative of the one or more of a shipping unit behavior data and the package information; and
generate, using a shipping unit clustering learning model and the one or more features, an output comprising cluster of a shipping unit.
